(19) United States
(12) Patent Application Publication
(10) Pub. No.: US 2017/0078412 A1
(43) Pub. Date: Mar. 16, 2017

(54) METHOD AND SYSTEM FOR PROVIDING GEOGRAPHICALLY RELEVANT WORK

(71) Applicant: Seven Seas Music, Inc., San Francisco, CA (US)

(72) Inventor: Brooke Marie Wentz, San Francisco, CA (US)

(73) Assignee: Seven Seas Music, Inc., San Francisco, CA (US)

(21) Appl. No.: 14/851,931

(22) Filed: Sep. 11, 2015

(51) Int. Cl. H04L 29/08; G06F 3/0484; G06F 3/0482; G06F 17/30

(52) U.S. Cl. CPC H04L 67/20; G06F 17/30241; G06F 3/04842; G06F 3/0482

(57) ABSTRACT

A map is displayed on a user device for a user to select one of a plurality of geographical regions as a geographical region of interest. A geographical area in the data records for the geographical region of the map selected by the user is set as a target geographical area. A plurality of work entries associated with the target geographical area are determined to be geographically relevant work entries. The user selects one of the geographically relevant work entries as a selected work entry. The work associated with the selected work entry is extracted and presented to the user through the user device.

### BACKGROUND OF THE INVENTION

1). Field of the Invention

This invention relates to a method and system for providing music and other works that are created by authors within particular geographic regions.

2). Discussion of Related Art

Online music services such as iTunes™, Rhapsody™, Pandora™, Spotify™ and others allow users to search for and then download or stream music works from a server to a client such as a personal computer or a mobile phone. Users may browse data records of work entries that are categorized based on “genre”, “mood”, “new and trending”, etc. Certain genres such as “world” are subcategorized for particular geographic regions such as “Africa”, “Asia”, “Caribbean”, etc.

Users are often interested in discovering music from particular geographic regions, in particular countries. Users may also be interested in discovering music from regions within countries, such as provinces or ethnic regions within a country. No system exists that allows a user to search for music works or other works in this manner. In particular, no system exists for map-based searching of music by artists from particular geographic regions or for searching for any other types of copyrighted works such as literary works, other musical works, dramatic works, pantomimes or choreographic works, pictorial, graphic or sculptural works, motion pictures and other audiovisual works, other sound recording, architectural works, and combinations thereof created by authors from particular geographic regions.

### SUMMARY OF THE INVENTION

The invention provides a method of providing geographically relevant work. The method includes storing, with at least one processor, data records, wherein the data records include geographical areas and a plurality of work entries associated with each geographical area, storing, with the at least one processor, a plurality of works wherein each work entry in the data records has a respective one of the works associated therewith, storing, with the at least one processor, a map with geographical regions, wherein each geographical area in the data records has a respective geographical region of the map associated therewith. The method further includes displaying, with the at least one processor, the map on a user device for a user to select one of the geographical regions as a geographical region of interest, receiving, with the at least one processor, a selection from the user device of the geographical region of interest on the map selected by the user, determining, with the at least one processor, the geographical area in the data records for the geographical region of the map selected by the user, thereby to determine a target geographical area. The method further includes determining, with the at least one processor, a plurality of work entries associated with the target geographical area to find a plurality of geographically relevant work entries, displaying, with the at least one processor, the plurality of geographically relevant work entries on the user device to the user to select one of the geographically relevant work entries as a selected work entry, receiving, with the at least one processor, a selection from the user device of the selected work entry selected by the user, extracting, with the at least one processor, the work associated with the selected work entry in the data records and presenting, with the at least one processor, the work that is extracted to the user through the user device.

The method may further include that the work is one of a literary work, a musical work, a dramatic work, a pantomime, a choreographic work, a pictorial work, a graphic work, a sculptural work, a motion picture, a sound recording, an architectural work or a combination thereof.

The method may further include that the work is a music work, further including providing, by the at least one processor, a playback function for listen to the work through a speaker of the user device.

The method may further include that the at least one processor includes at least a processor of a server and the user device is a client connected to the server over a network, further including receiving, with the processor of the server, a map request at the server over the network from the client, transmitting, with the processor of the server, the map from the server over the network to the client, transmitting, with the processor of the server, the plurality of geographically relevant work entries from the server over the network to the client and transmitting, with the processor of the server, the work from the server over the network to the client.

The method may further include receiving, with the at least one processor, a narrowing criteria, determining, with the at least one processor, a subset of the geographically relevant work entries based on the narrowing criteria and providing, by the at least one processor, the subset to the user device.

The method may further include that the narrowing criteria includes at least one of genre, vocaltype, mood, language and instrument, further including providing, with the at least one processor, a list of narrowing criteria together with the plurality of geographically relevant work entries, selection of one of the narrowing criteria in the list causing the reception of the narrowing criteria.

The method may further include that the narrowing criteria includes a sub-region within the target geographical area.

The method may further include that the target geographical area is a country and the sub-region is a sub-region of the country.

The method may further include that the sub-region is a first narrowing criteria, further including providing, with the at least one processor, a list of second narrowing criteria together with the plurality of geographically relevant work entries, selection of one of the narrowing criteria in the list causing the reception of the narrowing criteria.

The method may further include that the sub-region comprising the first narrowing criteria is provided before the second narrowing criteria is provided.

The invention also provides a system for providing geographically relevant work, including a processor, a computer readable medium connected to the processor; a data store on the computer readable medium, data records stored in the data store. The data records include geographical areas and a plurality of work entries associated with each geographical area, a plurality of works stored in the data store wherein each work entry in the data records has a respective one of the works associated therewith, a map with geographical regions with geographic regions stored in the data store, wherein each geographical area in the data records has a respective geographical region of the map associated therewith and a set of instructions on the computer readable medium that is executable by the processor. The set of instructions includes a map logic on the computer displaying the map on a user device for a user to select one of the geographical regions as a geographical region of interest, receiving a selection from the user device of the geographical region of interest on the map selected by the user, determining the geographical area in the data records for the geographical region of the map selected by the user, thereby to determine a target geographical area, and determining a plurality of work entries associated with the target geographical area to find a plurality of geographically relevant work entries. The set of instructions further includes a work logic displaying the plurality of geographically relevant work entries on the user device to the user to select one of the geographically relevant work entries as a selected work entry, receiving a selection from the user device of the selected work entry selected by the user, extracting the work associated with the selected work entry in the data records, and presenting the work that is extracted to the user through the user device.

The invention further provides a non-transitory computer readable medium having stored thereon a set of instructions that are executable by at least one processor to carry out a method of providing geographically relevant work.

### BRIEF DESCRIPTION OF THE DRAWINGS

The invention is further described by way of examples with reference to the accompanying drawings, wherein:

FIG. 1 is a block diagram of a system for providing geographically relevant works according to an embodiment of the invention;

FIG. 2 is flow chart illustrating storage of data records, works and a map;

FIG. 3 is an interactive diagram illustrating a method of providing geographically relevant work;

FIG. 4 is a screen shot illustrating a map and selection of a geographic area by a user;

FIG. 5 is a page that is displayed to the user after selecting a geographic region;

FIG. 6 is flow chart illustrating narrowing criteria;

FIG. 7 is a block diagram of a system for providing geographically relevant works according to an alternative embodiment of the invention; and

FIG. 8 is a block diagram of a machine in the form of a computer system forming part of the system of FIG. 1.

### DETAILED DESCRIPTION OF THE INVENTION

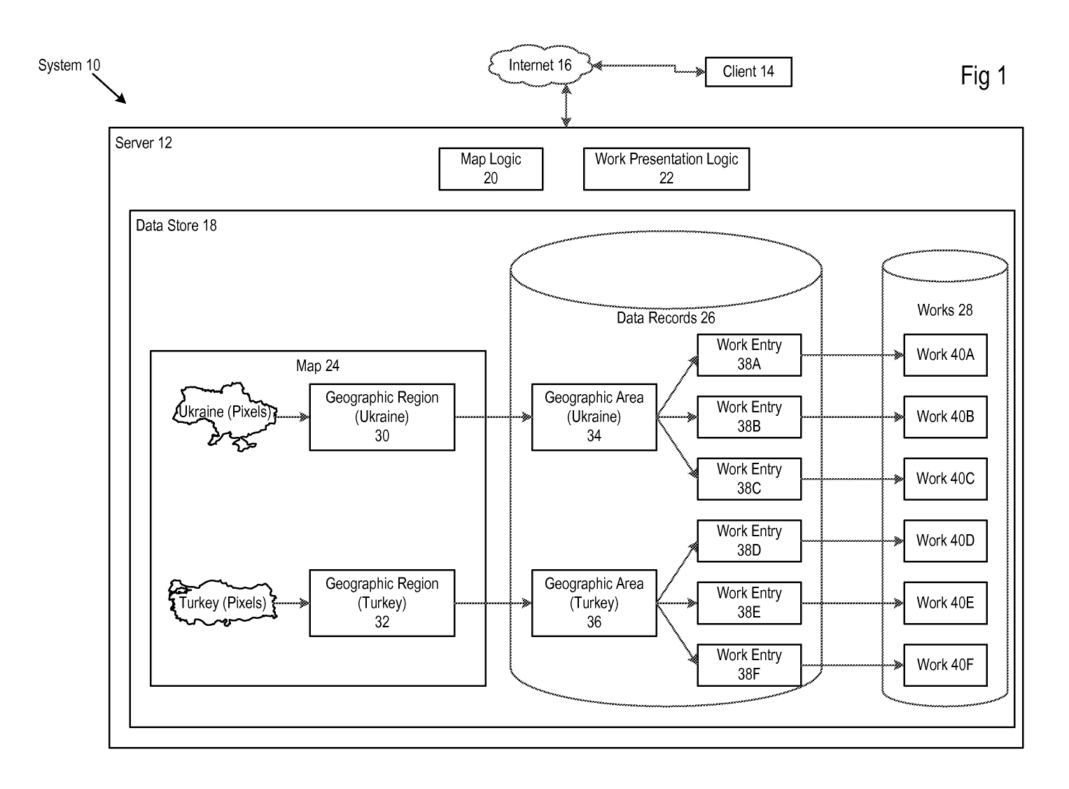

FIG. 1 of the accompanying drawings illustrates a system 10 for providing geographically relevant works, including a server 12 and a client 14 that are connected to one another over the Internet 16.

The server 12 includes a data store 18, map logic 20 and work presentation logic 22. A map 24, data records 26 and works 28 are stored in the data store 18.

The map 24 is a two-dimensional map of countries of the world. Each country is two-dimensionally represented within the map 24 for example by a subset of pixels that identify the respective country. A specific set of pixels that define the two-dimensional area of the Ukraine may for example be represented within the data store 18 as corresponding to the geographic region 30 for the Ukraine. Similarly, a different set of pixels representing the two-dimensional area of Turkey is represented by the geographic region 32 for Turkey. Each pixel is thus tagged as corresponding to a respective different geographic region.

The data records 26 include a plurality of geographic areas, represented as geographic areas 34 and 36 for the Ukraine and Turkey. The data records 26 also include a plurality of work entries 38A to F. In the present example, work entries 38A to C are associated with the geographic area 34 for the Ukraine and work entries 38D to F are associated with the geographic area 36 for Turkey. Each geographic area 34 or 36 in the data records 26 is associated with a respective geographic region 30 or 32 of the map 24.

The works 28 are, by way of example, music works. The works 28 include a work 40A that is associated with the work entry 38A in the data records 26. Similarly, works 40B to F are associated with the work entries 38B to F in the data records 26 respectively.

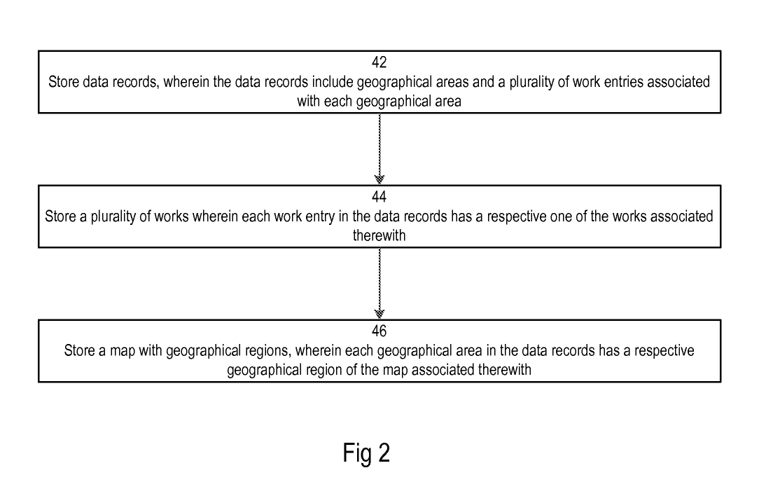

FIG. 2 show the processes for creating the data hereinbefore described. At 42, data records are stored, wherein the data records include geographical areas and a plurality of work entries associated with each geographical area. At 44, a plurality of works is stored wherein each work entry in the data records has a respective one of the works associated therewith. At 46, a map with geographical regions is stored, wherein each geographical area in the data records has a respective geographical region of the map associated therewith.

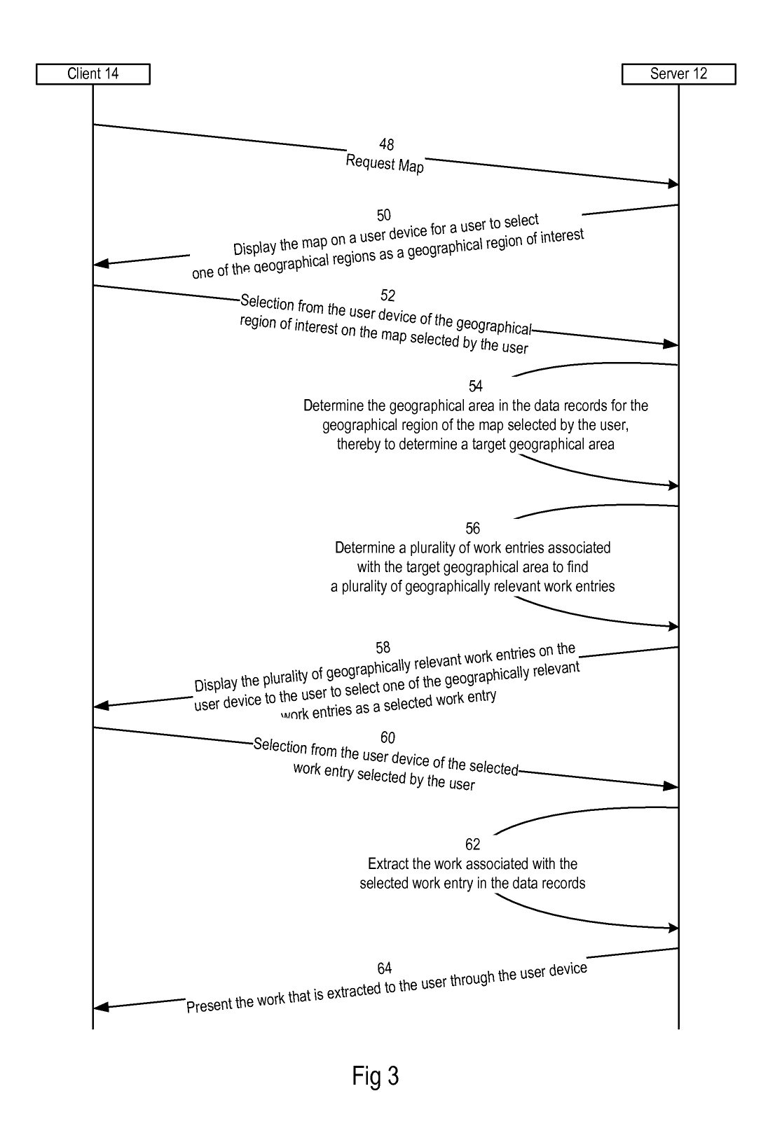

FIG. 3 illustrates the interaction between the server 12 and the client 14. At 48, the client 14 requests the map from the server 12. The map logic 20 in FIG. 1 is responsible for processing the request 48 and further operations 50, 52 and 54. At 50, the server 12 responds to the map request 48 to transmit the map to the client 14. The map is displayed on a user device (the client 14) for a user to select one of the geographical regions as a geographic region of interest. A script (not shown) is transmitted together with the map and is executed when a user selects a pixel of one of the geographical region as a geographical region of interest. When the user selects one of the geographical regions, the client 14, at 52, transmits a selection from the user device of the geographical region of interest on the map selected by the user, and the selection is received by the server 12.

At 54, the server 12 determines the geographical area in the data records 26 for the geographical region of the map selected by the user, thereby determining a target geographical area. Steps 56 to 64 are carried out by the work presentation logic 22 in FIG. 1. At 56, the server 12 determines a plurality of work entries associated with a target geographical area to find a plurality of geographically relevant work entries. At 58, the server 12 transmits a user interface with the plurality of geographically relevant work entries for display on the user device to the user to select one of the geographically work entries as a selected work entry. A script (not shown) is transmitted together with the geographically relevant work entries to detect selection of the selected work entry. At 60, the client 14 transmits the selection from the user device of the selected work entry selected by the user, and the selection is received by the server 12. At 62, the server 12 extracts the work associate with the selected work entry in the data records 26. At 64, the server 12 presents the work that is extracted to the user through the user interface. The server 12 may, for example, allow for a user at the client 14 to play a music track that can be heard through a speaker of the client 14.

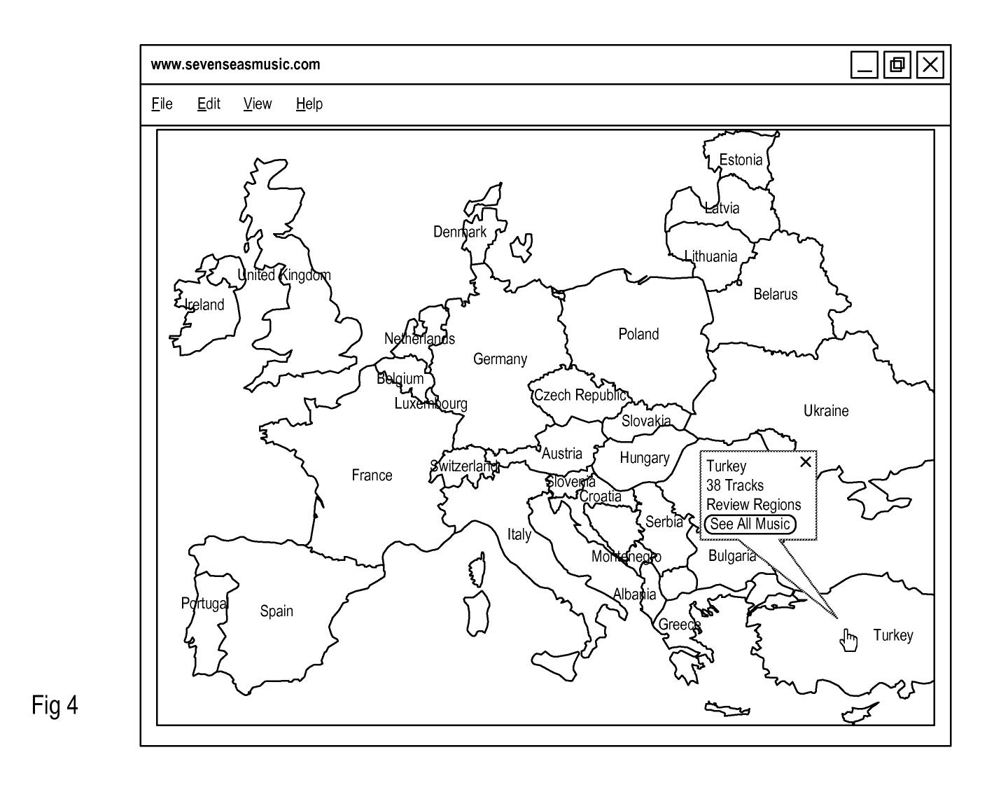

FIG. 4 illustrates the map 24 in FIG. 1 when it is displayed by a browser on the client 14 after step 50 in FIG. 3. The selection that is made by the user is executed in two steps. First, the user uses a cursor to mouse over the pixels of one of the geographic regions. In the present example, the country is Turkey. When the script that is transmitted with the map detects the cursor on one of the pixels of the geographic region, the script creates a callout bubble that lists the number of works, in the present example music tracks, for the geographic region. The client 14 has at this stage not transmitted the selection to the server 12. When the user moves the cursor over the callout bubble, and selects to see the works (“See All Music”), the client 14 transmits the selection to the server 12, i.e. step 52 in FIG. 3.

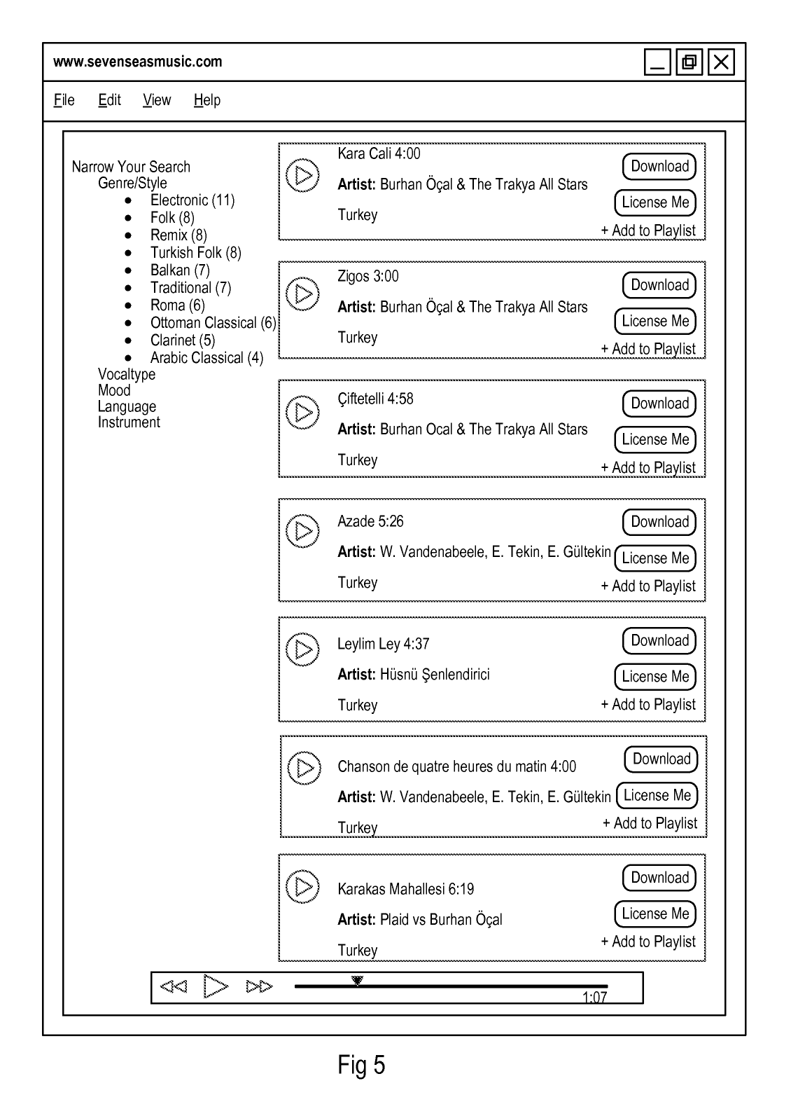

FIG. 5 shows a page of the user interface that is displayed by the client 14 after step 58 in FIG. 3. The page includes a plurality of entries, each providing access to a respective work for the region selected by the user. The user can select a play button next to one of the entries, which causes playback of the music track, in this example, through a speaker of the client 14.

Each one of the work entries 38A to F in FIG. 1 is further classified by genre/style, vocaltype, mood, language and instrument. The user can use the page in FIG. 5 to further narrow their search to find music that would fall within a particular one of these subcategories, but still for the geographic region selected by the user.

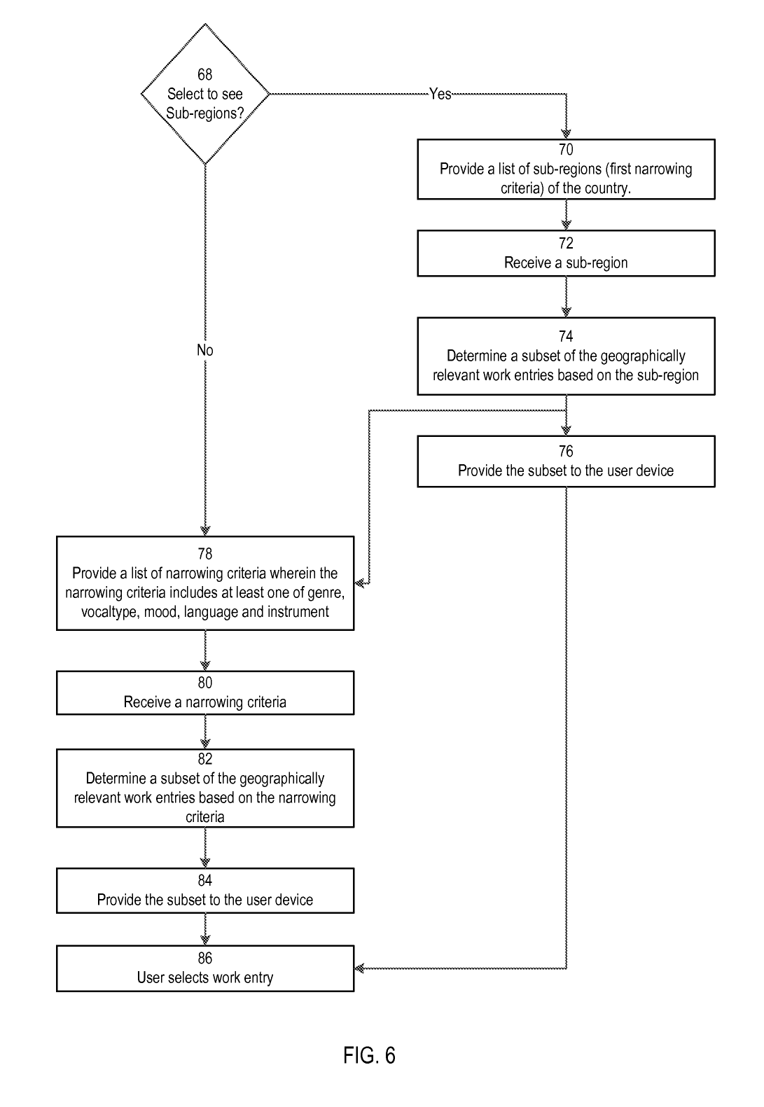

FIG. 6 shows details with respect to narrowing criteria that are presented to the user. As shown in FIG. 4, the user can select to review regions within a particular country or to see all music within a particular country. At 68, in FIG. 6, a determination is made whether the user selects to see sub-regions. If the user does select sub-regions, then, at 70, a list of sub-regions (comprising a first narrowing criteria) of the country is provided to the user through the user interface. The user subsequently selects one of the sub-regions, and transmits the sub-region to the server. At 72, the server 12 receives the sub-region. At 74, a subset of the geographically relevant works entries is determined based on the sub-region. By way of example, the region may be the country of Spain and the sub-region may be the Basque region within Spain. At 76, the subset of work entries for the sub-region is provided to the user device.

If the user at 68 does not select to see the sub-regions, but instead selects to see the works within the main region, then a list of narrowing criteria is provided to the user at 78. The narrowing criteria may for example be genre, vocaltype, mood, language and instrument as shown on the left in FIG. 5. It should be noted that if the process follows steps 70 to 76 to provide a subset of work entries for the sub-region, then the list of narrowing criteria is also provided at 78 together with the subset, in which case the sub-region forms a first narrowing criteria and the user can then select from a second narrowing criteria for genre, vocaltype, mood, language and instrument for the sub-region.

At 80, the server 12 receives the narrowing criteria selected from the list provided to the user at 78. At 82, a subset of geographically relevant work entries is determined based on the narrowing criteria received at 80. The subset will fall within the subset for the sub-region if the process has followed steps 70 to 76 for sub-region. If the process followed step 78 directly after step 68 without determining a sub-region, then the subset will fall within the large region, namely the country.

At 84, the subset is provided to the user device for selection of one of the work entries. At 86, the user selects one of the work entries to obtain access to the work. It should be noted that the user can select a work entry at 86 following either step 76 (where the subset is only based on the sub-region) or after step 84 (where the subset is based on the narrowing criteria for genre, vocaltype, mood, language and instrument with or without the narrowing criteria for sub-region).

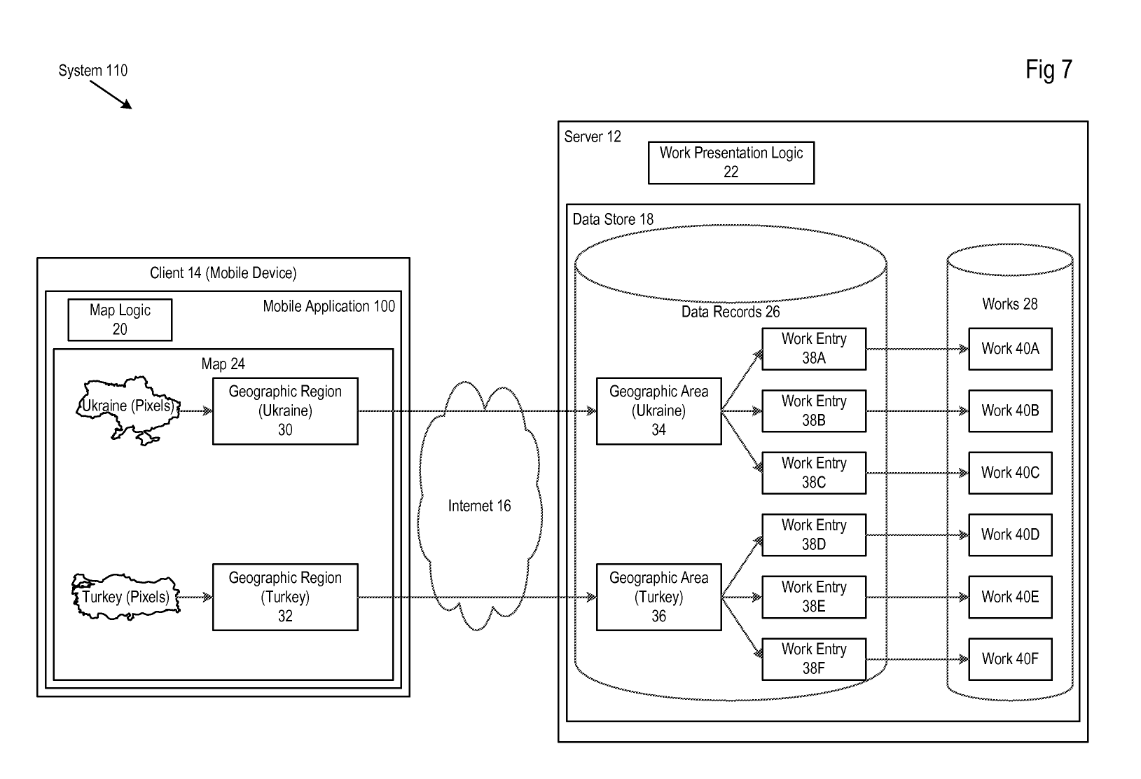

FIG. 7 shows a system 110 according to an alternative embodiment of the invention wherein the client 14 is a mobile device having a mobile application 100 stored thereon. The map logic 20 and the map 24 form part of the mobile application 100. The user can select a country using a tactile interface of the client 14, which causes selection of one of the geographic regions 30 or 32 forming part of the map 24 on the mobile application 100. The selected geographic region is then transmitted over the Internet 16 to the server 12. The work presentation logic 22 on the server 12 matches the geographic region 30 or 32 received from the client 14 to one of the geographic areas 34 or 36 in the data store 18 to find work entries 38A to F and to extract works 40A to F as hereinbefore described. The system 110 of FIG. 7 is the same as the system 10 in FIG. 1 in all other respects.

FIGS. 1 and 7 show embodiments that include a server and client architecture. In other embodiments more or fewer processing may be carried out by the client or the server may be eliminated and all processing can be done by the client.

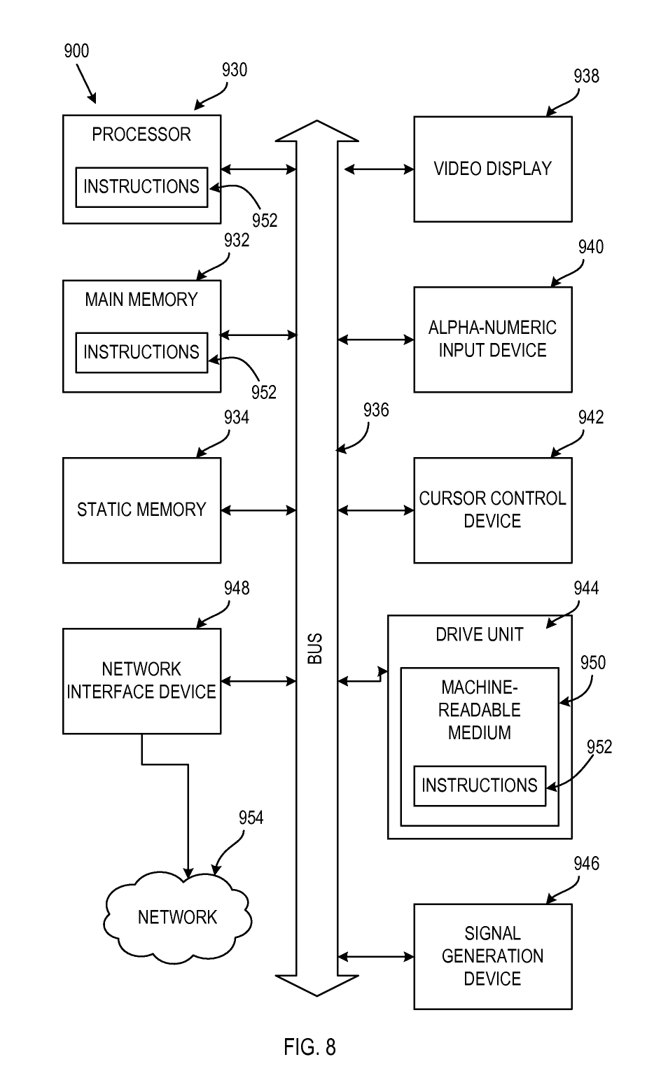

FIG. 8 shows a diagrammatic representation of a machine in the exemplary form of a computer system 900 within which a set of instructions, for causing the machine to perform any one or more of the methodologies discussed herein, may be executed. In alternative embodiments, the machine operates as a standalone device or may be connected (e.g., networked) to other machines. In a network deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 900 includes a processor 930 (e.g., a central processing unit (CPU), a graphics processing unit (GPU), or both), a main memory 932 (e.g., read-only memory (ROM), flash memory, dynamic random access memory (DRAM) such as synchronous DRAM (SDRAM) or Rambus DRAM (RDRAM), etc.), and a static memory 934 (e.g., flash memory, static random access memory (SRAM, etc.), which communicate with each other via a bus 936.

The computer system 900 may further include a video display 938 (e.g., a liquid crystal displays (LCD) or a cathode ray tube (CRT)). The computer system 900 also includes an alpha-numeric input device 940 (e.g., a keyboard), a cursor control device 942 (e.g., a mouse), a disk drive unit 944, a signal generation device 946 (e.g., a speaker), and a network interface device 948.

The disk drive unit 944 includes a machine-readable medium 950 on which is stored one or more sets of instructions 952 (e.g., software) embodying any one or more of the methodologies or functions described herein. The software may also reside, completely or at least partially, within the main memory 932 and/or within the processor 930 during execution thereof by the computer system 900, the memory 932 and the processor 930 also constituting machine readable media. The software may further be transmitted or received over a network 954 via the network interface device 948.

While certain exemplary embodiments have been described and shown in the accompanying drawings, it is to be understood that such embodiments are merely illustrative and not restrictive of the current invention, and that this invention is not restricted to the specific constructions and arrangements shown and described since modifications may occur to those ordinarily skilled in the art.

What is claimed:

1. A method of providing geographically relevant work, comprising:
storing, with at least one processor, data records, wherein the data records include geographical areas and a plurality of work entries associated with each geographical area;
storing, with the at least one processor, a plurality of works wherein each work entry in the data records has a respective one of the works associated therewith;
storing, with the at least one processor, a map with geographical regions, wherein each geographical area in the data records has a respective geographical region of the map associated therewith;
displaying, with the at least one processor, the map on a user device for a user to select one of the geographical regions as a geographical region of interest;
receiving, with the at least one processor, a selection from the user device of the geographical region of interest on the map selected by the user;
determining, with the at least one processor, the geographical area in the data records for the geographical region of the map selected by the user, thereby to determine a target geographical area;
determining, with the at least one processor, a plurality of work entries associated with the target geographical area to find a plurality of geographically relevant work entries;
displaying, with the at least one processor, the plurality of geographically relevant work entries on the user device to the user to select one of the geographically relevant work entries as a selected work entry;
receiving, with the at least one processor, a selection from the user device of the selected work entry selected by the user;
extracting, with the at least one processor, the work associated with the selected work entry in the data records; and
presenting, with the at least one processor, the work that is extracted to the user through the user device.

2. The method of claim 1, wherein the work is one of a literary work, a musical work, a dramatic work, a pantomime, a choreographic work, a pictorial work, a graphic work, a sculptural work, a motion picture, a sound recording, an architectural work or a combination thereof.

3. The method of claim 1, wherein the work is a music work, further comprising:
providing, by the at least one processor, a playback function for listen to the work through a speaker of the user device.

4. The method of claim 1, wherein the at least one processor includes at least a processor of a server and the user device is a client connected to the server over a network, further comprising:
receiving, with the processor of the server, a map request at the server over the network from the client;
transmitting, with the processor of the server, the map from the server over the network to the client;
transmitting, with the processor of the server, the plurality of geographically relevant work entries from the server over the network to the client; and
transmitting, with the processor of the server, the work from the server over the network to the client.

5. The method of claim 1, further comprising:
receiving, with the at least one processor, a narrowing criteria;
determining, with the at least one processor, a subset of the geographically relevant work entries based on the narrowing criteria; and
providing, by the at least one processor, the subset to the user device.

6. The method of claim 5, wherein the narrowing criteria includes at least one of genre, vocaltype, mood, language and instrument, further comprising:
providing, with the at least one processor, a list of narrowing criteria together with the plurality of geographically relevant work entries, selection of one of the narrowing criteria in the list causing the reception of the narrowing criteria.

7. The method of claim 5, wherein the narrowing criteria includes a sub-region within the target geographical area.

8. The method of claim 5, wherein the target geographical area is a country and the sub-region is a sub-region of the country.

9. The method of claim 8, wherein the sub-region is a first narrowing criteria, further comprising:
providing, with the at least one processor, a list of second narrowing criteria together with the plurality of geographically relevant work entries, selection of one of the narrowing criteria in the list causing the reception of the narrowing criteria.

10. The method of claim 9, wherein the sub-region comprising the first narrowing criteria is provided before the second narrowing criteria is provided.

11. A system for providing geographically relevant work, comprising:
a processor;
a computer readable medium connected to the processor;
a data store on the computer readable medium;
data records stored in the data store, wherein the data records include geographical areas and a plurality of work entries associated with each geographical area;
a plurality of works stored in the data store wherein each work entry in the data records has a respective one of the works associated therewith;
a map with geographical regions with geographic regions stored in the data store, wherein each geographical area in the data records has a respective geographical region of the map associated therewith; and
a set of instructions on the computer readable medium that is executable by the processor, including:
a map logic on the computer displaying the map on a user device for a user to select one of the geographical regions as a geographical region of interest,
receiving a selection from the user device of the geographical region of interest on the map selected by the user,
determining the geographical area in the data records for the geographical region of the map selected by the user, thereby to determine a target geographical area, and
determining a plurality of work entries associated with the target geographical area to find a plurality of geographically relevant work entries; and
a work logic displaying the plurality of geographically relevant work entries on the user device to the user to select one of the geographically relevant work entries as a selected work entry,
receiving a selection from the user device of the selected work entry selected by the user,
extracting the work associated with the selected work entry in the data records, and
presenting the work that is extracted to the user through the user device.

12. A non-transitory computer readable medium having stored thereon a set of instructions that are executable by at least one processor to carry out a method of providing geographically relevant work, comprising:
storing, with at least one processor, data records, wherein the data records include geographical areas and a plurality of work entries associated with each geographical area;
storing, with the at least one processor, a plurality of works wherein each work entry in the data records has a respective one of the works associated therewith;
storing, with the at least one processor, a map with geographical regions, wherein each geographical area in the data records has a respective geographical region of the map associated therewith;
displaying, with the at least one processor, the map on a user device for a user to select one of the geographical regions as a geographical region of interest;
receiving, with the at least one processor, a selection from the user device of the geographical region of interest on the map selected by the user;
determining, with the at least one processor, the geographical area in the data records for the geographical region of the map selected by the user, thereby to determine a target geographical area;
determining, with the at least one processor, a plurality of work entries associated with the target geographical area to find a plurality of geographically relevant work entries;
displaying, with the at least one processor, the plurality of geographically relevant work entries on the user device to the user to select one of the geographically relevant work entries as a selected work entry;
receiving, with the at least one processor, a selection from the user device of the selected work entry selected by the user;
extracting, with the at least one processor, the work associated with the selected work entry in the data records; and
presenting, with the at least one processor, the work that is extracted to the user through the user device.
